(19) United States
(12) Patent Application Publication
(10) Pub. No.: US 2003/0186696 A1
(43) Pub. Date: Oct. 2, 2003

(54) Method for transmitting values in telecommunication networks

(76) Inventors: Uwe Klatt, Berlin (DE); Thomas Ryll, Berlin (DE); Manfred Lilge, Berlin (DE)

Correspondence Address: BELL, BOYD & LLOYD, LLC, P. O. BOX 1135, CHICAGO, IL, 60690-1135, US

(21) Appl. No.: 10/306,901

(22) Filed: Nov. 27, 2002

Related U.S. Application Data
(60) Provisional application No. 60/334,403, filed on Nov. 29, 2001.

(51) Int. Cl. H04Q 7/20

(52) U.S. Cl. 455/432.1; 455/432.3

(57) ABSTRACT

In the world of mobile telecommunications, roaming agreements have become successful which enable a user to use his/her terminal in a foreign mobile radio network (i.e., in another one than his/her own). Although this established method currently only applies to telecommunication services, it can be extended to the mobile payment transactions in that the existing clearing means from the roaming agreements from the existing business relationships are utilized to effect a method for transferring values in telecommunication networks.

### BACKGROUND OF THE INVENTION

The present invention relates to a method for transmitting values in telecommunication networks, particularly for the payment of goods and services.

The purchasing process in a telecommunication network involves four roles:

the provider of a service or a product who demands to be paid for this (also called the merchant);

the customer or consumer of the service provided or of the product who wishes to pay for this (also called the consumer);

the payment service provider (PSP) who handles the payment traffic between provider and customer; and

credit card institutes (CCI) which conclude contracts with providers and issue credit cards to customers. In the following discussions, this is not restricted to credit cards. Other means for payment also can be used such as a customer card, a debit account, an EC card and many others.

In the tradition of the communications world, the network operator acts both as provider and as payment service provider. He/she offers telephony services to his/her subscribers (customers) and charges for them via the existing billing systems (telephone account or debiting the prepaid debit account).

As the telecommunication networks have been opened up (e.g., by Parlay, http://www.parlay.org/) and within public data networks (e.g., the Internet), third parties also act as providers which provide their own services. The content providers already widely used on the Internet can be mentioned here who provide information (contents) against payment, or also online shops. As a rule, however, they do not have their own billing systems. The billing services needed are provided to the provider and to the customer by the payment service provider.

When the customer and the provider register at the same payment service provider, the purchase of a service or of a product can be billed for the provider by the payment service provider. However, as soon as the customer wants to purchase a service or goods from a provider who has not registered his/her business in the same country, two payment service providers are also involved, as a rule. The first payment service provider serves the customer in his/her first home country (consumer PSP) and the other serves the provider in the second home country (provider PSP). The separation into two PSPs is here mapped onto the separation by borders as an example, but also can happen just as well in one country.

Using the credit card which, in the meantime, has become established worldwide, a customer in a foreign country can pay in the foreign country. The provider transmits this transaction to the resident credit card institute (the acquirer) and finally receives his/her money from the latter. The provider credit card institute also transmits the transaction data to the credit card institute of the customer (the issuer) (in the home country of the customer), via separate mechanisms. After that, the payment service provider issues an invoice with this transaction to the customer, which, as a rule, also contains a fee for using the credit card in a foreign country via which the cost of the communication between the provider credit card institute and customer credit card institute are paid for.

It is an object of the present invention to specify a roaming method for transmitting values in a telecommunication network or also between two telecommunication networks, which is particularly suitable for the international payment traffic.

### SUMMARY OF THE INVENTION

In the world of mobile telecommunication, roaming agreements have become successful which enable a user to use his/her terminal also in a foreign mobile radio network (i.e., in a different one from his/her own). Although this established method currently applies only to telecommunication services, it also can be extended to mobile payment transactions by utilizing the existing clearing means from the roaming agreements from the existing business relations.

A provider concludes a contract about the handling of payment methods with his/her network operator (provider PSP). The customer is and remains a mobile radio customer with his/her own network operator and can use the required services of any providers via this network operator; that is to say, the network operator is consumer PSP.

When the two network operators act with one another via the existing roaming means, this has a number of advantages. In principle, a provider can only bill for services of a consumer if he/she also maintains a contractual relationship with the consumer PSP. By utilizing roaming means, however, the provider also can use all billing means of the consumer at his/her consumer PSP via his network operator and it is no longer necessary to conclude contracts with the individual other network operators. As a result, a larger circle of customers is reached. This results in the advantage for the customer that the overall fees will drop.

The provider PSP, in contrast, would guarantee the payment of a customer (in a foreign network) to the provider. As a result, the means of payment of provider and customer are independent of one another. The provider PSP achieves higher incomes from the transactions since he/she processes these like a credit card institute, can provide the provider with a payment guarantee and, in return, charges transaction costs.

The customer can select, independently of the respective provider, between means of payment which already exist; for example, prepaid account, debit card payment, EC card and credit card. These means of payment are administered by the customer PSP and can be selected by the customer or in accordance with rules predetermined by the customer for each payment. It is impossible to have a case where there is a discrepancy between means of payment offered by the provider and existing means of payment by the customer whereby no payment is produced.

The two network operators PSP are involved more in the turnovers due to transactions between provider and customer because they can no longer bill only for the transport services in their network. The customer PSP, for example, bills the customer with the foreign use of his/her means of payment because, of course, he/she also has greater expenditure in clearing with the provider PSP.

Additional features and advantages of the present invention are described in, and will be apparent from, the following Detailed Description of the Invention and the Figures.

### BRIEF DESCRIPTION OF THE DRAWINGS

FIG. 1 shows, as prior art, a provider-customer relationship in which both users are registered in the same network.

FIG. 2 shows a purchasing process in which customer and provider are located in different countries and the goods/services are paid for via credit card.

FIG. 3 shows the use of a credit card by a customer in the manner according to the present invention.

FIG. 4 shows the money flows arising in accordance with the structure outlined in FIG. 3.

### DETAILED DESCRIPTION OF THE INVENTION

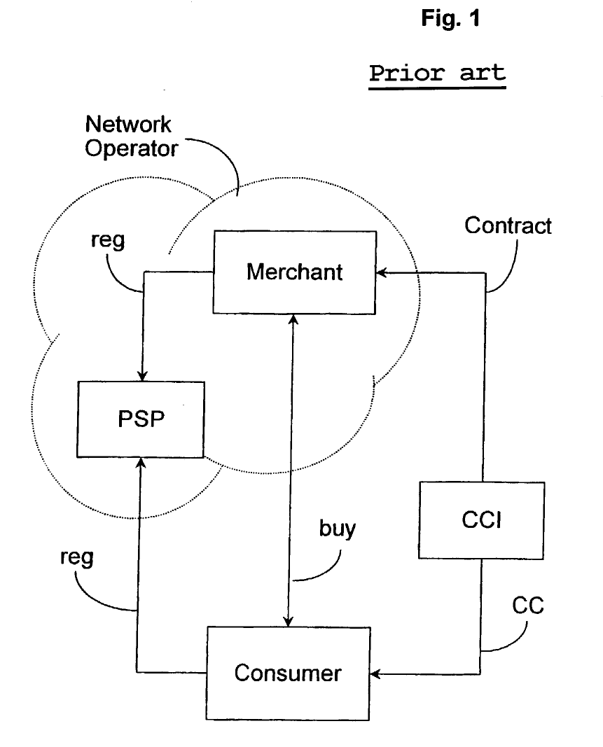

In the payment process via a credit card transaction, shown in FIG. 1, the network operator is only involved as service provider for communication services. He/she is excluded from the actual flow of money of the transactions. His/her income is low in relation to the credit card turnover. The billing accounts offered by the network operator (conventional billing or credit account) are also excluded from an international utilization given these prerequisites.

The problem for the provider is that he/she must conclude billing contracts with the popular financial institutes, which can demand relatively high fees in comparison with the turnover, in order to reach a large circle of customers. If the provider does not support a method of payment preferred by the customer, the business will probably not be transacted.

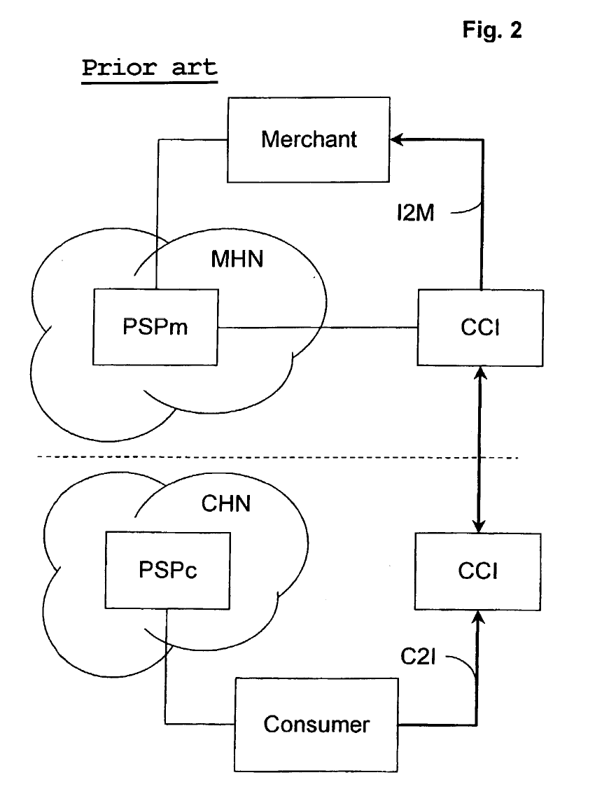

FIG. 2 then shows the flows of money in a case where a purchase contract for goods or services has been concluded. Customer and provider are, in each case, at home in different networks. When a payment is carried out, the customer (consumer) has a contract with a first credit card institute (C21). The provider (merchant) also has a contract with a credit card institute (12M). In the best case, it is the same credit card institute (CCI); otherwise, it is still necessary again to conclude contracts. If not, the transmission of money will not function.

The present invention can be implemented, for example, by the “Payment @vantage” system of Siemens. This is a real-time accounting system which administers accounts both for customers and for providers. This accounting system is thus operated by the payment service provider.

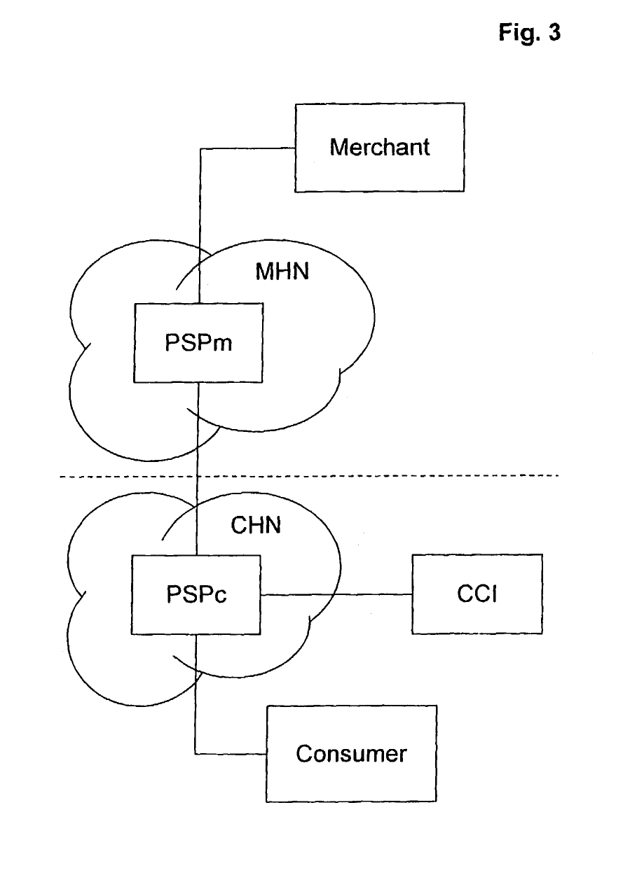

FIG. 3 shows, by way of an example, the case of the use of a credit card by a customer (consumer) for making a payment to a provider (merchant). The customer has a business relationship with another network provider (PSPc) in the home network of the customer (MHN) than the provider (PSPm), who has his/her own home network (CHN).

In this example, the customer has a contract with a credit card institute (CCI), but the provider does not need to have a contract with this credit card institute. At this point, it should be mentioned that other forms of payment are also possible: prepaid by PPS (Prepaid Server), or postpaid by ABC (Administration and Billing Center). These “internal” forms of payment of the consumer PSP will present for him/her the most attractive way of paying because, in this case, the consumer PSP does not have to pay for any commissions (such as, for example, in the case of credit cards).

According to the present invention, the home network of the customer (CHN) provides the following services:

debiting the credit card of the customer on order by the “foreign” provider;

charging a fee for the customer for international payments; and

performing clearing of the foreign network provider.

In the home network of the provider (MHN), the following additionally happens:

charging a fee for the provider for international payments; and

performing clearing with the other network provider.

Use of (debit) accounts instead of billing via credit cards (prepaid accounts or telephone account) is also useful. This additionally simplifies the scenario and, in addition, is much more attractive for the network operators, (see above).

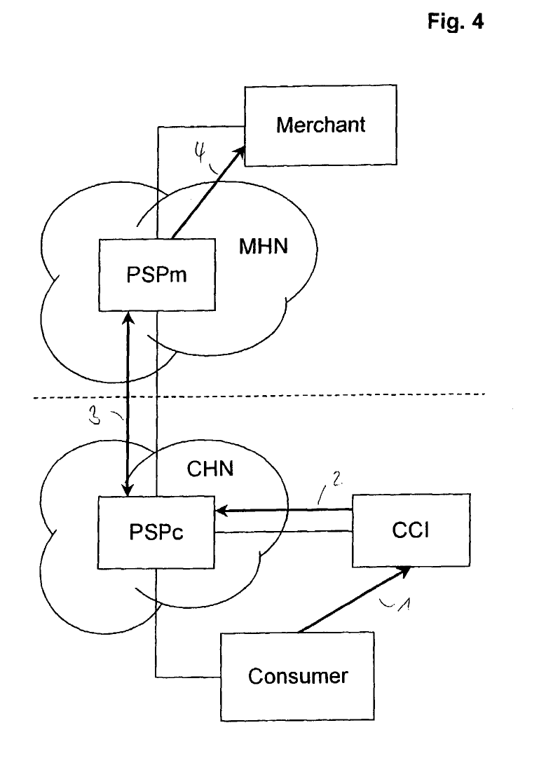

The flows of money belonging to the scenario shown in FIG. 3 are found again in FIG. 4.

It can be seen that there only needs to be one business relationship as a basis for the provider (merchant). As such, there is a single point of entry for the payments and transactions for the provider. This point of entry charges additional fees for performing an international payment.

The payment service provider at the customer end (PSPc) maintains business relationships with all financial institutes (CCI) at which his/her customers (consumers) have contracts. In the case of credit payments, he/she acts as dealer who wishes to receive a payment from the customer (2), with respect to the credit card institute; i.e., the credit card institute cannot recognize the actual provider (merchant). On the invoice paid by the customer (1), the network operator appears as dealer. Information about the original dealer and the service received can be made visible, for example, in the transaction details so that the customer also obtains a detailed overview of his/her transactions.

The clearing between the payment service provider of the customer (PSPc) and provider (PSPm) occurs directly between these two (3) and can take place by extending the pre-existing roaming agreement, and the existing technical means such as “TAP3” for GSM or other clearing formats (e.g., CIBER) can be used.

The provider obtains his/her money (4) from his/her own payment service provider (PSPm). He/she receives additional fees from the dealer for carrying out the transaction.

Although the present invention has been described with reference to specific embodiments, those of skill in the art will recognize that changes may be made thereto without departing from the spirit and scope of the present invention as set forth by the hereafter appended claims.

1. A method for transferring values between a consumer, who wishes to procure goods or services, and a merchant who provides the goods or services, the method comprising the steps of:
providing that the consumer is a subscriber of a payment service in a first communication network;
providing that the merchant is a subscriber of a payment service and a second communication network; and
utilizing clearing procedures from roaming agreements between the first and second communication networks for effecting the transfer.

2. A method for transferring values between a consumer and a merchant as claimed in claim 1, wherein a provider of the payment service in the first communication network appears as provider to a payment institute.

3. A method for transferring values between a consumer and a merchant as claimed in claim 1, wherein the merchant is guaranteed performance of a payment transaction by the payment service in the second communication network.

4. A method for transferring values between a consumer and a merchant as claimed in claim 1, wherein the consumer has a plurality of payment forms available which are administered by the payment service in the first communication network, and a specific form of payment is selected by rules predetermined by the consumer.

5. A method for transferring values between a consumer and a merchant as claimed in claim 1, wherein the payment services are billed in favor of a provider of the payment service depending upon an expenditure for roaming needed.

6. A system for transferring values between a consumer, who wishes to procure goods or services, and a merchant who provides the goods or services, comprising:
a payment service, in a first communication network, to which the consumer is a subscriber;
a payment service, in a second communication network, to which the merchant is a subscriber; and
clearing procedures from roaming agreements between the first and second communication networks, wherein the clearing procedures are used for effecting the transfer.
